(19) United States
(12) Patent Application Publication
(10) Pub. No.: US 2026/0267738 A1
(43) Pub. Date: Sep. 10, 2026

(54) APPARATUSES, SYSTEMS, AND METHODS FOR ADJUSTABLE ERROR CHECK AND SCRUB (ECS) CYCLE LENGTH

(71) Applicant: Micron Technology, Inc., Boise, ID (US)

(72) Inventors: Wesley W. Borie, Boise, ID (US); Sujeet Ayyapureddi, Boise, ID (US)

(73) Assignee: Micron Technology, Inc., Boise, ID (US)

(21) Appl. No.: 19/465,243

(22) Filed: Jan. 30, 2026

Related U.S. Application Data
(60) Provisional application No. 63/822,354, filed on Jun. 12, 2025.
(60) Provisional application No. 63/767,938, filed on Mar. 6, 2025.

(51) Int. Cl. G06F 11/10

(52) U.S. Cl. CPC G06F 11/106; G06F 11/1016

(57) ABSTRACT

A memory device includes a memory array organized into banks, with each bank including a number of rows, each of which stores a number of codewords. Over the course an error check and scrub (ECS) cycle, ECS addresses for each codeword are sequentially generated and each codeword is checked for errors and those errors are corrected. The memory device includes an ECS cycle setting. Based on the ECS cycle setting, an ECS cycle determines how many ECS operations to perform per ECS command. In this manner, the length of an ECS cycle may be varied. The ECS circuit may generate ECS addresses by updating a bank address each time an ECS command is received, and by updating a code word address each time the bank address wraps, and updating a row address each time the code word address wraps.

### CROSS REFERENCE TO RELATED APPLICATIONS

This This application claims the benefit under 35 U.S.C. § 119 of the earlier filing date of U.S. Provisional Application Serial No. 63/767,938 filed Mar. 6, 2025 and U.S. Provisional Application Serial No. 63/822,354 on Jun. 12, 2025. The entire contents of both applications are hereby incorporated by reference herein in their entirety for any purpose.

### BACKGROUND

This disclosure relates generally to semiconductor devices, such as semiconductor memory devices. The semiconductor memory device may include a number of memory cells which are used to store information. The stored information may be encoded as binary data, and each memory cell may store a single bit of the information. Information may decay or change in the memory cells due to a variety of different errors, which may lead to one or more bits of incorrect information (e.g., bits with different states that the bit which was originally written) being read out from the memory device.

There may be many applications where it is useful to ensure a high fidelity of information read out from the memory. Memory devices may include error correction circuits, which may be used to determine if the information read out of the memory cells contains any errors compared to the data written into the memory cells and may correct discovered errors. The memory device may periodically use the error correction circuits to repair errors in information stored within the memory array by scanning every memory cell of the memory array as part of an error check and scrub (ECS) cycle.

### BRIEF DESCRIPTION OF THE DRAWINGS

FIG. 1 is a block diagram of a semiconductor device according to some embodiments of the present disclosure.

FIG. 2 is a block diagram of ECS logic according to some embodiments of the present disclosure.

FIG. 3 is a timing diagram of ECS operations according to some embodiments of the present disclosure.

FIG. 4 is an example sequence of ECS operations according to some embodiments of the present disclosure.

FIGS. 5A and 5B show example ECS cycles being performed with different ECS cycle settings according to some embodiments of the present disclosure.

FIG. 6 is a flow chart of a method of performing ECS operations over an adjustable length of ECS cycle according to some embodiments.

FIG. 7 is a flow chart of a method of generating an ECS address according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

A memory device may include a memory array which has a number of memory cells, each located at the intersection of a word line (row) and digit line (column). During a read or write operation, a row may be activated, and data may be read from, or written to, the memory cells along the activated row. Each row may include memory cells which store a number of bits of data and a number of bits of error correction information (e.g., data bits and error correction bits), which may be used to correct up to a certain number of errors in the data bits. For example, a row may include one or more codewords, each of which includes J data bits and K error correction bits, which may be used to correct some number of the bits of the codeword. For example, in a single error correction (SEC) device, up to one bit of the codeword may be corrected. During a write operation the error correction bits may be generated by an error correction circuit based on the data written to the memory cells of the row. During a read operation the error correction circuit may use the error correction bits to determine if the read data bits are correct and may correct any errors which are found in the data as it is being provided off the memory device.

The error correction circuit may identify errors in read data and correct the read data before it is provided to data terminals of the memory device. However, the error may remain in the codeword stored in the memory array. The device may perform error check and scrub (ECS) operations to remedy this. In an ECS operation, an address of a codeword is generated and the codeword from the current ECS address is read out, an error, if present, is corrected by the error correction circuit, and then the corrected codeword is written back to the memory array. The memory performs an ECS cycle by performing ECS operations on each codeword of the memory by working through a sequence of every codeword address.

The memory device receives commands, such as manual ECS (MECS) commands, which cause it to perform ECS operations. The number of ECS commands per ECS cycle may be based on the number of code words in the memory device. The memory may generally expect to receive commands at an average rate based on the total number of ECS command to get through every codeword in the device divided by the length of the ECS cycle. There may be some circumstances where it is useful to vary the length of the ECS cycle without changing the rate at which the device is receiving ECS commands. For example, if a particular memory part is expected to have lower data retention characteristics than a baseline, the ECS cycle length may be reduced for that part to increase the rate at which errors are repaired without needing to alert the controller.

The present disclosure is directed to apparatuses, systems, and methods for adjustable ECS cycle length. An example memory device includes an ECS cycle setting. The ECS cycle setting may be multiplier with respect to a ‘normal’ or default ECS cycle length. That setting determines how long the ECS cycle will be by varying the number of ECS operations performed per ECS command. For example, if the ECS cycle setting indicates that the ECS cycle should be half of the default ECS cycle length, then two ECS operations are performed for each ECS command. Since the average rate of ECS commands is expected to be steady, this will cause the ECS cycle to complete in half of the default amount of time. Some ECS cycle settings may be achieved by changing the number of ECS operations performed per ECS commands between different ECS commands. For example, to achieve 75% of the normal ECS cycle length, then the device may alternate between performing two ECS operations per ECS command and one ECS operation per ECS command.

When the controller issues an ECS command to the memory, it may track which bank the ECS operation is being performed in, for example so that it can issue access commands to a different bank. Since the ECS cycle setting can change the rate at which the memory works its way through the address space, it may be useful to ensure that the memory can track which bank the ECS operation(s) will be performed in. An example memory device of the present disclosure may change which bank it is performing ECS operations on with each ECS command. For example, responsive to a first ECS command one or more operations will be performed in a first bank, and responsive to a second ECS command one or more operations will be performed in a second bank, and so forth. In this manner, the controller can keep a simple count of the number of ECS commands issued to track which bank the ECS operation(s) of that command will be performed in.

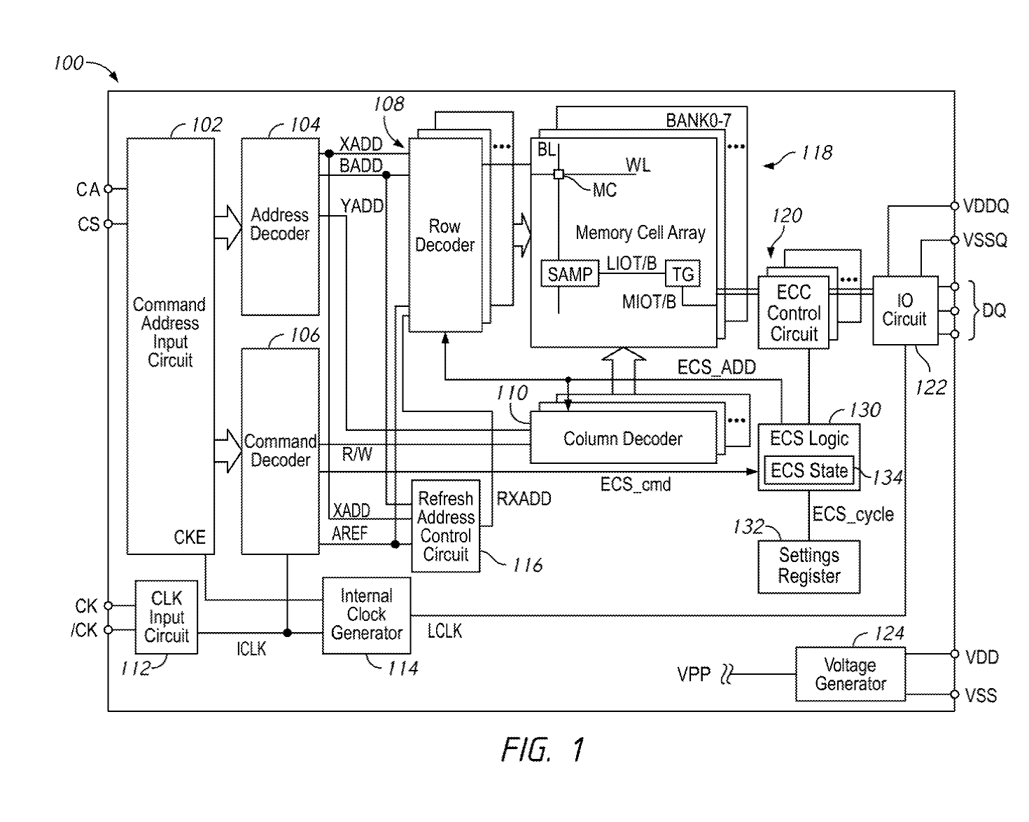

FIG. 1 is a block diagram of a semiconductor device according to an embodiment of the disclosure. The semiconductor device 100 may be a semiconductor memory device, such as a DRAM device integrated on a single semiconductor chip.

The semiconductor device 100 includes a memory array 118. The memory array 118 is shown as including a plurality of memory banks. In the embodiment of FIG. 1, the memory array 118 is shown as including eight memory banks BANK0-BANK7. More or fewer banks may be included in the memory array 118 of other embodiments. Each memory bank includes a plurality of word lines WL, a plurality of bit lines BL, and a plurality of memory cells MC arranged at intersections of the plurality of word lines WL and the plurality of bit line BL. The selection of the word line WL is performed by a row decoder 108 and the selection of the bit lines BL is performed by a column decoder 110. In the embodiment of FIG. 1, the row decoder 108 includes a respective row decoder for each memory bank and the column decoder 110 includes a respective column decoder for each memory bank. The bit lines BL are coupled to a respective sense amplifier (SAMP). Read data from the bit line BL is amplified by the sense amplifier SAMP, and transferred to read/write amplifiers 120 over complementary local data lines (LIOT/B), transfer gate (TG), and complementary main data lines (MIOT/B) which are coupled to an error correction code (ECC) control circuit 120. Conversely, write data outputted from the ECC control circuit 120 is transferred to the sense amplifier SAMP over the complementary main data lines MIOT/B, the transfer gate TG, and the complementary local data lines LIOT/B, and written in the memory cell MC coupled to the bit line BL.

The semiconductor device 100 may employ a plurality of external terminals that include command and address (C/A) terminals coupled to a command and address bus to receive commands and addresses, and a CS signal, clock terminals to receive clocks CK and /CK, data terminals DQ to provide data, and power supply terminals to receive power supply potentials VDD, VSS, VDDQ, and VSSQ.

The clock terminals are supplied with external clocks CK and /CK that are provided to an input circuit 112. The external clocks may be complementary. The input circuit 112 generates an internal clock ICLK based on the CK and /CK clocks. The ICLK clock is provided to the command decoder 106 and to an internal clock generator 114. The internal clock generator 114 provides various internal clocks LCLK based on the ICLK clock. The LCLK clocks may be used for timing operation of various internal circuits. The internal data clocks LCLK are provided to the input/output circuit 122 to time operation of circuits included in the input/output circuit 122, for example, to data receivers to time the receipt of write data.

The C/A terminals may be supplied with memory addresses. The memory addresses supplied to the C/A terminals are transferred, via a command/address input circuit 102, to an address decoder 104. The address decoder 104 receives the address and supplies a decoded row address XADD to the row decoder 108 and supplies a decoded column address YADD to the column decoder 110. The address decoder 104 may also supply a decoded bank address BADD, which may indicate the bank of the memory array 118 containing the decoded row address XADD and column address YADD. The C/A terminals may be supplied with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

The commands may be provided as internal command signals to a command decoder 106 via the command/address input circuit 102. The command decoder 106 includes circuits to decode the internal command signals to generate various internal signals and commands for performing operations. For example, the command decoder 106 may provide a row command signal to select a word line and a column command signal to select a bit line.

The device 100 may receive an access command which is a write command. When the write command is received, and a bank address, a row address, and a column address are timely supplied as part of the write operation, and write data is supplied through the DQ terminals to the ECC control circuit 120. The write data supplied to the data terminals DQ is written to a memory cells in the memory array 118 corresponding to the row address and column address. The write command is received by the command decoder 106, which provides internal commands so that the write data is received by data receivers in the input/output circuit 122. Write clocks may also be provided to the external clock terminals for timing the receipt of the write data by the data receivers of the input/output circuit 122. The write data is supplied via the input/output circuit 122 to the ECC control circuit 120. The ECC control circuit 120 may generate a number of parity bits based on the write data, and the write data and the parity bits may be provided as a codeword to the memory array 118 to be written into the memory cells MC.

The device 100 may receive an access command which is a read command. When a read command is received, and a bank address, a row address and a column address are timely supplied with the read command, a codeword including read data and read parity bits is read from memory cells in the memory array 118 corresponding to the row address and column address. The read command is received by the command decoder 106, which provides internal commands so that read data from the memory array 118 is provided to the ECC control circuit 120. The ECC control circuit 120 may use the parity bits in the codeword to determine if the codeword includes any errors, and if any errors are detected, may correct them to generate a corrected codeword (e.g., by changing a state of the identified bit(s) which are in error). The corrected codeword (without the parity bits) is output to outside the device 100 from the data terminals DQ via the input/output circuit 122.

The ECC control circuit 120 may be used to ensure the fidelity of the data read from a particular group of memory cells to the data written to that group of memory cells. The device 100 may include a number of different ECC control circuits 120, each of which is responsible for a different portion of the memory cells MC of the memory array 118. For example, there may be one or more ECC control circuits 120 for each bank of the memory array 118.

Each ECC control circuit 120 may receive a codeword which includes a certain number of data bits and a certain number of parity bits (e.g., 128 data bits and 8 parity bits). The data bits may be provided from either from the IO circuit 122 or the memory array 118 depending on if it is a read or write operation, and the ECC control circuit 120 uses the parity bits to locate and correct potential errors in the codeword. For example, as part of a write operation an ECC control circuit 120 may receive 128 bits of data from the IO circuit 122 and may generate 8 parity bits based on those 128 data bits to form a codeword with 136 total bits. The codeword may be written to the memory array 118. As part of an example read operation, the ECC control circuit 120 may receive a codeword with 128 data bits and 8 parity bits from the memory cell array 118. The ECC control circuit 120 may generate new parity bits from the 128 data bits, and then compare the new parity bits to the read parity bits in the codeword to generate syndrome bits. The syndrome bits may be used to locate errors in the codeword and the ECC control circuit 120 and may correct them if any are found before supplying the data bits to the IO circuit 122. While various embodiments may be discussed with reference to ECC circuits which use codewords where 8 parity bits are used to find one error in 128 data bits, it should be understood that these are for explanatory purposes only, and that other numbers of data bits, error bits, and parity bits may be used in other example embodiments.

During a read operation, the ECC control circuit 120 checks the codeword and locates and corrects any errors before providing the corrected codeword to the IO circuit 122. Accordingly, if there was an error, it may remain in the codeword stored in the memory array 118, since the correction is made between the memory array 118 and the IO circuit 122. The memory device 100 includes error check and scrub (ECS) logic 130, which is used to correct errors stored within the memory array 118. Over the course of an ECS cycle, the ECS circuit 130 generates a sequence of ECS addresses ECS_ADD which cover all the codewords stored in the memory array 118. The ECS addresses ECS_ADD include row, column, and bank addresses in order to specify a codeword. For each ECS address in the sequence, the ECS circuit 130 operates the address decoder 104 and command decoder 106 to perform a read operation on the memory cells which store the codeword associated with the ECS address, such that the codeword is read out to the ECC circuit 120 and corrected, and then instead of providing the corrected codeword off the device 100 as in a normal read, the corrected codeword is written back to the memory array 118 to the original location specified by the ECS address. In some embodiments, only a portion of the codeword (e.g., only the data bits or only the data bit changed by the correction) may be written back to overwrite the previous codeword. By cycling through a sequence of addresses which includes all codewords, the ECS circuit 130 may perform an ECS cycle to repair the errors in the memory cells array 118.

The memory may receive ECS commands ECS_cmd, such as manual ECS (MECS) commands along the C/A terminals. The command decoder 106 provides the ECS_cmd to the ECS logic 130, which performs one or more ECS operations (e.g., on one or more codewords) responsive to the ECS command. The number of ECS operations may be based on an ECS state logic circuit of the ECS logic 130 and an ECS cycle setting ECS_cycle stored in a settings register 132. The settings register 132 may be a mode register of the device 100 or a fuse register. The ECS_cycle setting determines a length of the ECS cycle.

The ECS cycle (e.g., an ECS operation on each codeword in the device 100) may generally be performed over a set amount of time. The ECS_cycle setting acts as a multiplier which alters the length of the ECS cycle by telling the ECS state logic how many ECS operations to perform for a command. Under a default or baseline setting (e.g., ECS_cycle = 1x), the memory device 100 receives a number of ECS commands A equal to the number of codewords over a set span of time B, such as 24 hours. By changing how many ECS operations are performed, the rate at which all codewords are cycled may be changed without changing how frequently the ECS commands are received. For example, if ECS cycle setting tells the ECS logic to perform two ECS operations per ECS command, then over the course of A ECS commands over B hours, every codeword will be refreshed twice, effectively making the ECS cycle length B/2 (e.g., 12 hours). However, the device is still receiving ECS commands at an average rate of A/B.

The device 100 may also receive commands causing it to carry out one or more refresh operations as part of a self-refresh mode. In some embodiments, the self-refresh mode command may be externally issued to the memory device 100. In some embodiments, the self-refresh mode command may be periodically generated by a component of the device. In some embodiments, when an external signal indicates a self-refresh entry command, the refresh signal AREF may also be activated. The refresh signal AREF may be a pulse signal which is activated when the command decoder 106 receives a signal which indicates entry to the self-refresh mode. The refresh signal AREF may be activated once immediately after command input, and thereafter may be cyclically activated at desired internal timing. The refresh signal AREF may be used to control the timing of refresh operations during the self-refresh mode. Thus, refresh operations may continue automatically. A self-refresh exit command may cause the automatic activation of the refresh signal AREF to stop and return to an IDLE state. The refresh signal AREF is supplied to the refresh control circuit 116. The refresh control circuit 116 supplies a refresh row address RXADD to the row decoder 108, which may refresh one or more word lines WL indicated by the refresh row address RXADD.

The power supply terminals are supplied with power supply potentials VDD and VSS. The power supply potentials VDD and VSS are supplied to an internal voltage generator circuit 124. The internal voltage generator circuit 124 generates various internal potentials VPP, VOD, VARY, VPERI, and the like based on the power supply potentials VDD and VSS supplied to the power supply terminals. The internal potential VPP is mainly used in the row decoder 108, the internal potentials VOD and VARY are mainly used in the sense amplifiers SAMP included in the memory array 118, and the internal potential VPERI is used in many peripheral circuit blocks.

The power supply terminals are also supplied with power supply potentials VDDQ and VSSQ. The power supply potentials VDDQ and VSSQ are supplied to the input/output circuit 122. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

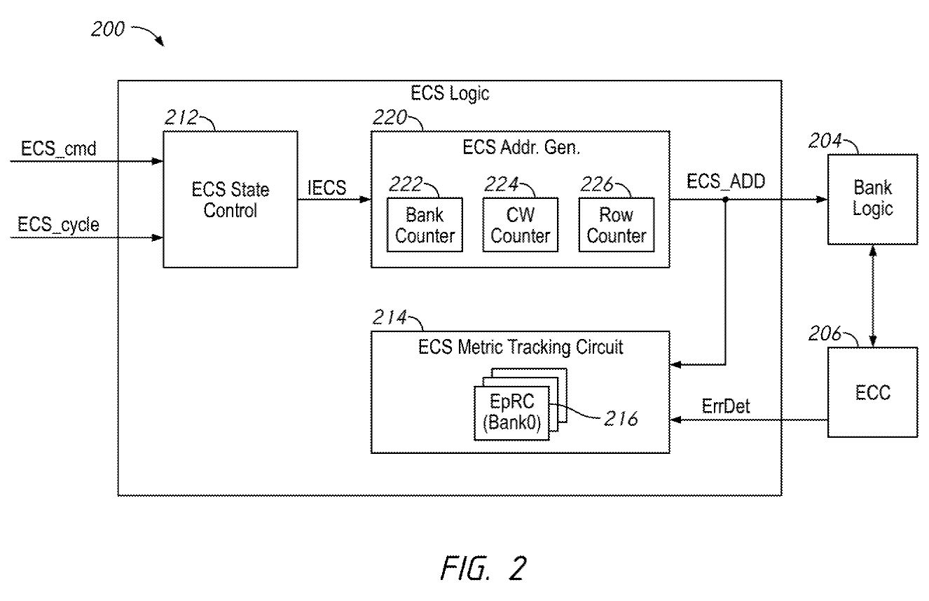

FIG. 2 is a block diagram of ECS logic according to some embodiments of the present disclosure. The ECS logic 200 may implement the ECS logic 130 of FIG. 1 in some embodiments. The ECS logic 200 of FIG. 2 receives an ECS command ECS_cmd, such as an MECS command, and performs one or more ECS operations. As part of the ECS operation(s), the ECS logic 200 provides one or more ECS addresses ECS_ADD. The number of ECS operations performed per ECS command ECS_cmd is based on the value of the ECS cycle setting ECS_cycle stored in a settings register such as a mode register and/or fuse array (e.g., settings register 132 of FIG. 1).

The ECS logic 200 includes an ECS state control circuit 212, an ECS address generator circuit 220, and an optional ECS metric tracking circuit 214. The ECS state control circuit 212 provides one or more activations of an internal ECS signal IECS to an ECS address generator circuit 220 responsive to the ECS command ECS_cmd. The ECS address generator circuit 220 generates an ECS address ECS_ADD for each activation of the internal ECS signal IECS. The ECS address ECS_ADD, along with one or more other ECS signals (not shown) are provided to the bank logic regions 204 of the array, such as to the row decoder (e.g., 108 of FIG. 1) and column decoder (e.g., 110 of FIG. 1). Responsive to the ECS address ECS_ADD, and the ECS signals (not shown), the bank logic 204 performs an ECS operation on the codeword specified by the ECS address ECS_ADD.

The ECS state control circuit 212 generates different numbers of activations of the internal ECS signal IECS based on the value of the setting ECS_cycle. In this manner, the ECS state control circuit 212 can perform different numbers of ECS operations responsive to an ECS command ECS_cmd. In some embodiments, the setting ECS_cycle may act as a multiplier giving the number of ECS operations to perform per ECS cycle relative to a ‘baseline’ number of ECS operations per ECS command. For example, the value of ECS_cycle may have a value of 1x, which may cause the ECS state control circuit 212 to perform the baseline number of ECS operations. If the value of ECS_cycle is 2x, then the ECS state control circuit 212 may perform twice the baseline number of ECS operations per ECS command. In some embodiments, the baseline number of ECS operations per ECS command may be one, and so the value of ECS_cycle may represent the average number of ECS operations per ECS command.

In some embodiments, the value of ECS_cycle may lead to an average number of ECS operations per ECS command that does not divide evenly. For example, if the base line number of ECS operations per ECS command is 1, and the value of ECS_cycle is 1.5. To achieve the proper average number of he ECS operations per ECS command when the average number of ECS operations does not divide into a whole number of operations per command, the state control circuit 212 may generate different numbers of IECS activations to different ECS commands in order to achieve the proper average. For example, if the baseline number of ECS operations per command is 1, and the ECS cycle setting is 1.5x, then the ECS state control circuit may alternate between providing 2 activations of IECS and 1 activation of IECS for each ECS command. In this way, the average number of ECS operations per command is 1.5 while performing a whole number of ECS operations for any given command.

The memory device may receive ECS commands ECS_cmd at a rate such that every codeword is refreshed over the course of a baseline ECS cycle period when the baseline number of ECS operations are performed per ECS command. For example, if the baseline is 1 ECS operation per ECS command, and the baseline ECS cycle period is 24 hours, then the memory may generally expect to receive ECS commands at a rate based on the total number of codewords on the device divided by 24 hours. Since the rate may generally be constant, and the number of codewords in the device is a constant, the value of ECS_cycle may change the duration of the ECS cycle period away from its baseline value. For example, if the value of ECS_cycle is 2x, then the ECS cycle period will be half of its baseline value, while if the value of ECS_cycle is 0.5x, then the ECS cycle period will be twice its baseline value.

The ECS address generator circuit 220 includes counter circuits 222, 224, and 226 to generate the ECS address. For example, the ECS address generator circuit 220 includes a bank counter circuit 222, a codeword counter circuit 224, and a row counter circuit 226. The bank counter circuit 222 generates a bank address portion of ECS_ADD, the codeword counter circuit 224 is used to generate a column address portion of ECS_ADD, and the row counter circuit 226 is used to generate a row address portion of ECS_ADD. During an ECS operation, the column address and row address portions of ECS_ADD are directed to the column and row decoders respectively in the bank logic 204 of the bank specified by the bank address portion of ECS_ADD. The row specified by the row address portion is activated, and the codeword specified by the column address portion is read out to the ECC circuit 206 (e.g., 120 of FIG. 1), corrected if applicable, and then written back to the same location (if a correction is made).

The counter circuits 222, 224, and 226 may generally operate in an ordered fashion. For example, if there is one ECS operation ECS command (e.g., ECS_cycle is 1x) then for each ECS command a first counter circuit updates, for example by incrementing a value of the address to the next address in a sequence. When the first counter wraps, going from a last address in the sequence back to a first address in the sequence, it sends a signal to a next sequential counter circuit, causing that counter circuit to update. When the second counter wraps, it updates a third counter. In some embodiments, more complicated logic may be used when multiple ECS operations are performed per command. For example, a first counter may be updated on a first ECS operation per ECS command, but the second counter may be updated for subsequent ECS operations when multiple ECS operations are performed per command.

In the example ECS address generator circuit 220 of FIG. 2, the counters are ordered from bank counter 222 to codeword counter 224 to row counter 226. For each ECS command ECS_cmd, the bank counter 222 updates the bank address portion. In other words, each ECS command ECS_cmd causes the one or more ECS operations to be performed in a different bank than the bank where the one or more ECS operations were performed responsive to the previous ECS command. For example, for each ECS_cmd, the bank counter 222 increments. When the bank address counter 222 wraps (e.g., goes from an address for a last bank back to an address for a first bank), the code word counter circuit 224 updates. When the code word counter circuit 224 wraps, the row counter circuit 226 updates.

When multiple ECS operations are performed responsive to an ECS command, then the bank counter circuit 222 updates for the first IECS generated from that ECS_cmd and then subsequent IECS activations cause the codeword counter circuit 224 to update even if the bank counter hasn’t wrapped. When the bank counter circuit updates (e.g., responsive to the next ECS command ECS_cmd), the codeword counter circuit 224 may be reset back to the value it had when the ECS command was received. For example, if there are 3 ECS operations performed per ECS command, and the bank and codeword counters start at 0, then responsive to the first ECS command ECS operations will be performed in Bank0 on CW0, CW1, and CW2, then on the next ECS command ECS operations will be performed in Bank1 on CW0, CW1, and CW2, and so forth. In this manner, the ECS address updates in a manner that over a sequence of ECS commands, the same code word(s) are refreshed in each of the banks, and then the next codeword(s) along the same row in each of the banks, and then eventually once all the codewords along a row have been refreshed the addresses advance to the next row.

The ECS logic circuit 200 may also include an ECS metric tracking circuit 214 that records various metrics about the memory’s performance based on the errors detected during ECS operations. The ECS metric tracking circuit 214 receives an error detected signal ErrDet from the ECC circuit 206 when the ECC circuit 206 detects an error in the codeword specified by ECS_ADD. The ECS metric tracking circuit 214 tracks information like the total number of errors counted (EC) and the row address (from the ECS_ADD) and number of errors along the row with the highest errors in an errors per row count (EpRC).

The EpRC value may be managed by counting a number of errors detected (e.g., a number of times ErrDet is activated) as the codewords along a row are counted and then comparing that value to a previously stored EpRC value. If the new count is greater, it replaces the stored EpRC value and the row address of the current row from ECS_ADD is saved and replaces a previous address. In the example ECS logic of FIG. 2, since the bank counter 222 updates before the row counter 226, the ECC metric tracking circuit 214 may include a stored EpRC value for each bank. For example, if there are L bank, there are L EpRC values 216 stored in the ECS metric tracking circuit 214. Each of the L EpRC values 216 stores a count value and a row address for the row with the highest errors in that bank. In some embodiments, the overall EpRC value may be tracked by maintaining L+1 count values and addresses, with the extra representing an overall value for the whole memory array.

In an example operation, when an ECS operation is performed, the bank address portion of the ECS_ADD is used to select the EpRC counter 216 associated with that bank. If the signal ErrDet is received, then the count value is increased. When the row counter circuit 226 wraps, the ECS metric tracking circuit 214 compares whichever of the stored bank EpRC values is highest to the stored overall EpRC count. If that count is higher, then it overwrites the overall EpRC count, and the row address and bank address is written to the overall register.

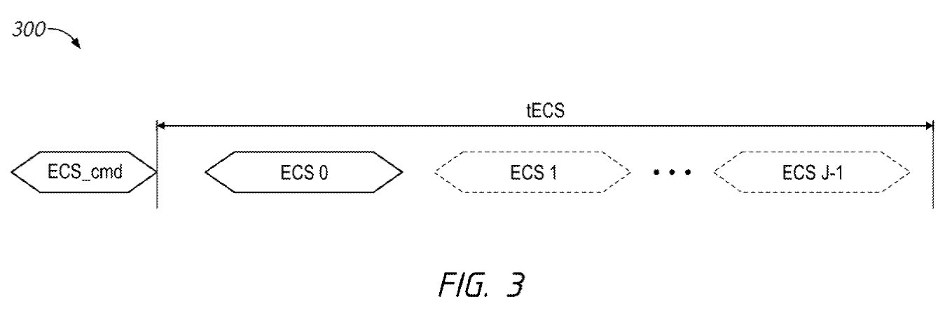

FIG. 3 is a timing diagram of ECS operations responsive to an ECS command according to some embodiments of the present disclosure. The timing diagram 300 of FIG. 3 may represent an ECS command (e.g., MECS and/or ECS_cmd) and ECS operations performed by a memory device such as 100 of FIG. 1 and/or an ECS logic circuit such as 200 of FIG. 2. The timing diagram 300 represents one or more ECS operations being performed responsive to an ECS command ECS_cmd.

When the memory receives an ECS command ECS_cmd, the memory performs ECS operations during a timing window tECS. During this time, the bank where the ECS operation is being performed cannot be accessed. Accordingly, after sending an ECS command, the controller will wait at least tECS before sending a subsequent command to that bank. In some embodiments, other banks may still be accessed during this time. For example, after sending an ECS command to a first bank, during the window tECS, the controller may send a read or a write command to a second bank. Since which bank the ECS operation(s) are being performed in changes with each ECS command, the controller may keep a simple count of ECS commands, modulo the number of banks, to determine which bank the ECS operation(s) are being performed in, and thus which other bank(s) may be accessible during tECS.

The time tECS may be based, in part, on a maximum number of ECS operations that may need to be performed responsive to the ECS command. For example, if the highest setting (e.g., the shortest ECS cycle length) of the ECS cycle setting calls for four ECS operations per tECS, then the timing tECS may be set to accommodate up to four ECS operations.

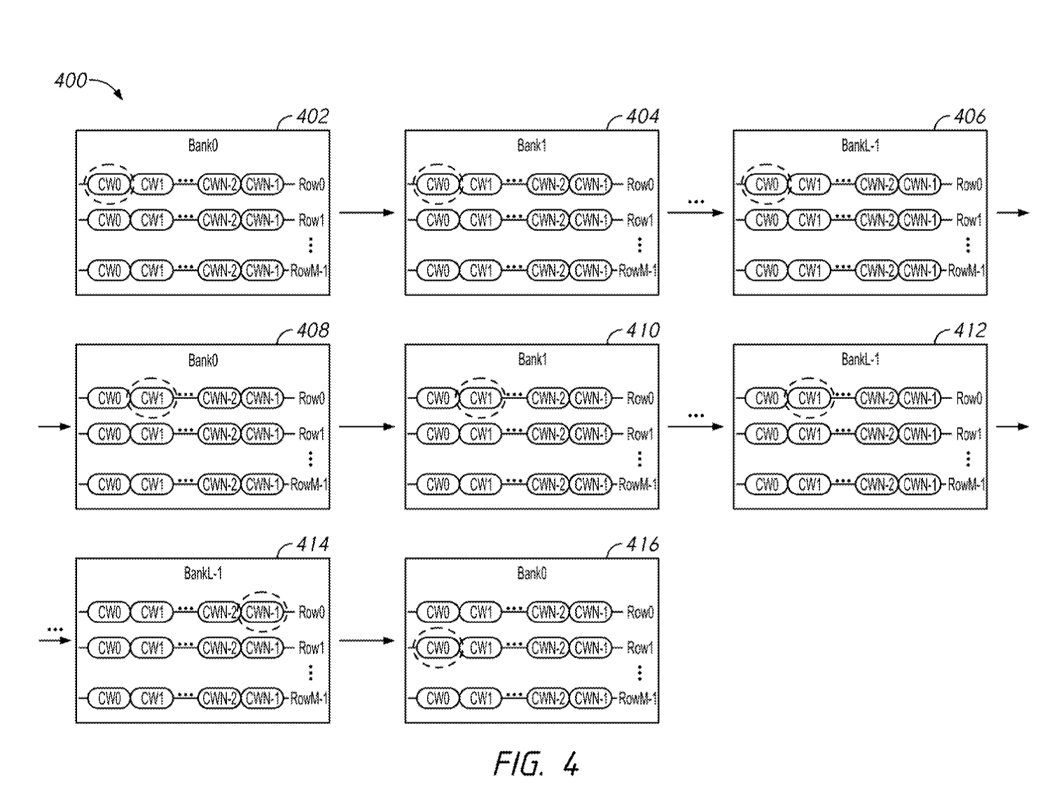

FIG. 4 is an example sequence of ECS operations according to some embodiments of the present disclosure. The sequence 400 may be implemented by a memory device such as the memory device 100 of FIG. 1 and/or a portion thereof such as the ECS logic circuit 200 of FIG. 2. The example sequence 400 shows how ECS operations proceed through an example memory array over the course of a portion of an ECS cycle. In this example, one ECS operation is performed per ECS command (e.g., ECS_cycle = 1 and the baseline number of ECS operations per ECS command is 1).

Each of the boxes 402-416 shows where an ECS operation is performed, with each box 402-416 representing a different ECS command. Some of the boxes represent adjacent ECS commands. For example, box 404 is the ECS command which immediately follows the ECS command represented by box 402. Some of the boxes represent a gap in ECS commands. For example, the ECS command of box 406 is separated by a number of ECS commands from the ECS command of box 404. In each of the boxes 402-416, a circle is used to represent which code word the ECS operation is being performed on.

The example memory device in the sequence 400 includes L memory banks, each of which includes M rows, each with N codewords along them. In the example sequence 400, each of the counters initialize to a value of 0. So responsive to a first ECS command, the first box 402 shows an ECS operation being performed on CW0 of Row0 in Bank0. The next ECS command, shown in box 404, shows an ECS operation being performed on CW0 of Row0 in Bank1. This proceeds for the first L ECS commands, until box 406, which shows the Lth ECS command being performed on CW0 of Row0 in BankL-1. On a next ECS operation, the bank address counter (e.g., 222 of FIG. 2) will wrap, causing the CW counter (e.g., 224 of FIG. 2) to update. Box 408 shows the next ECS command (e.g., the L+1th ECS command of the sequence) which shows an ECS operation on CW1 of Row0 in Bank0. Box 410 shows the next ECS command, where an ECS operation is performed on CW1 of Row0 of Bank1. The sequence continues in this fashion, with box 412 showing the ECS operation performed on CW1 of Row0 of L-1. After this command the CW counter will update again. After many more ECS commands, box 414 shows an ECS operation being performed on the final codeword of the first row of the last bank CWN-1 of Row0 of BankL-1. Since this is the last bank in the sequence, the next ECS command will wrap the bank counter, which will also cause the CW counter to wrap, causing the row counter (e.g., 226 of FIG. 2) to update. This causes the next ECS operation, shown in box 416, to be on CW0 of Row1 of Bank0.

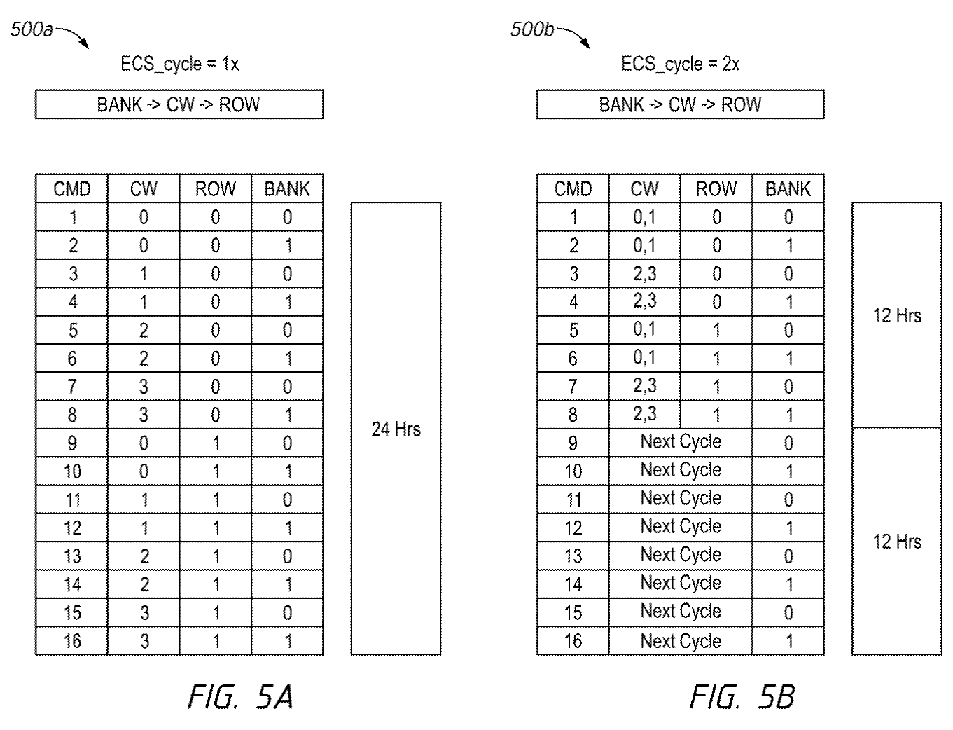

FIGS. 5A and 5B show example ECS cycles being performed with different ECS cycle settings according to some embodiments of the present disclosure. FIGS. 5A and 5B represent simplified views of an ECS cycle being performed in an example memory device such as 100 of FIG. 1 or portion thereof such as the ECS logic circuit 200 of FIG. 2. The example cycle 500a of FIG. 5A shows a cycle where the ECS_cycle setting is 1x and the example cycle 500b of FIG. 5B shows a cycle where the ECS_cycle setting is 2x. In both cycles 500a and 500b, the baseline number of ECS operations per ECS command is one. The cycle 500a may be similar to the cycle 400 of FIG. 4. The cycle 500b is also similar except that multiple ECS operations are performed for each command.

In order to present a more simplified view, FIGS. 5A and 5B describe ECS cycles in an example memory device that has two banks, each of which have two rows, with each row having four codewords along it. Larger numbers of banks, rows, and codewords per row may generally be used in other embodiments, however a more limited number is shown in FIGS. 5A and 5B to simplify and shorten the example cycles. The cycles 500a and 500b are represented as tables, with each row representing a different ECS command numbered from 1 to 16. The next three columns show the values of the ECS address, given as a code word (column) address, a row address, and a bank address. Since in this example there are 4 codewords per row, the CW address can have values between 0 and 3, while the row and bank addresses have values of 0 or 1 since there are two of each. A separate block to the right of the table shows a period of time.

In the cycle 500a of FIG. 5A, the ECS cycle setting is 1x, and so each ECS command causes one ECS operation to be performed. This may represent a baseline operation. In the example of FIGS. 5A and 5B, the baseline ECS cycle duration is 24 hours. Since there are 16 total codewords on the example device, and since the baseline is one ECS operation per ECS command, it takes 16 total ECS commands to complete an ECS cycle. Accordingly, ECS commands may be received at a rate of 1 ECS command every 1.5 hours (on average).

In the cycle 500a, the first command causes an ECS operation to be performed on CW0, Row0, Bank0. The next command causes an ECS on CW0, Row0, Bank1. Since that causes the bank counter wrap, the CW counter updates and the third ECS command causes an ECS operation on CW1, Row0, Bank0. This proceeds until the 16^{th} ECS command which causes an ECS operation on CW3 in Row1 of Bank1. The 17^{th} ECS command would start a new ECS cycle.

The cycle 500b shows an example of the same memory device, receiving ECS commands at a same average rate, but where the ECS_cycle setting is 2x. In the example cycle 500b, two ECS operations are performed for each ECS command. Since only the CW address changes for the two operations performed for a given ECS command in this example embodiment, the two ECS operations are represented by two CW addresses separated by a comma. For a first ECS command, the first ECS operation is performed on CW0 of Row0 of Bank0. Since there is a second ECS operation responsive to the same ECS command, rather than update the bank address, the CW address updates instead, and the second ECS operation responsive to ECS command 1 is on CW1 of Row0 and Bank0. On the second ECS command, an ECS operation is performed on CW0 of Row0 of Bank1 and on CW1 of Row0 of Bank1. The third ECS command causes ECS operations on CW2 of Row0 and Bank0 and on CW3 of Row0 and Bank0. This continues until the 8^{th} ECS command, which causes an ECS operation on CW2 of Row1 of Bank1 and an ECS operation on CW3 of Row1 of Bank1. This completes the ECS cycle, and the 9^{th} command would begin a next ECS cycle on CW0 and CW1 of Row0 and Bank0. Since it is generally expected that ECS commands are received at the same average rate, this means that the cycle 500b completes in half the time (e.g., 12 hours) as the cycle 500a.

As may be seen by comparing the Bank column of both the cycles 500a and 500b, even when the ECS_cycle command causes multiple ECS operations to be performed per ECS command, the bank address changes with each ECS command. This makes it relatively easy to track which bank the ECS operation(s) are being performed in for any given command. For example, by updating a counter for each ECS command where the counter tracks the bank address and wraps when the maximum bank address value is reached.

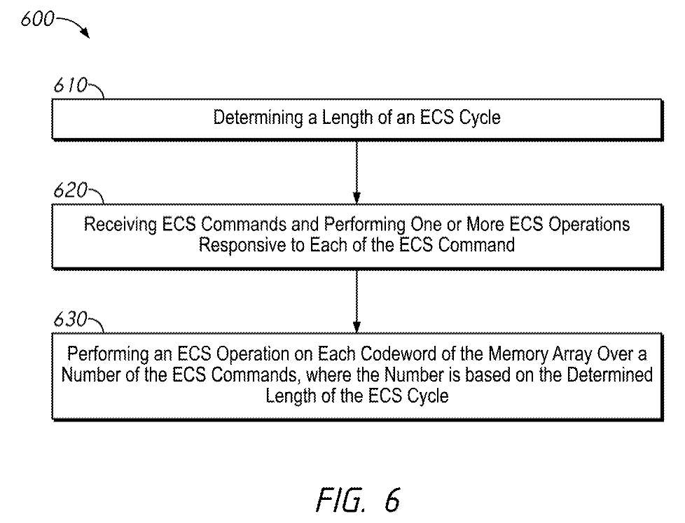

FIG. 6 is a flow chart of a method of performing ECS operations over an adjustable length of ECS cycle according to some embodiments. The method 600 of FIG. 6 may in some embodiments, be performed by any of the apparatuses or systems described herein. For example, the method 600 may be performed by the memory device 100 of FIG. 1 and/or a portion thereof such as the ECS logic circuit 200 of FIG. 2.

The method 600 of FIG. 6 begins with block 610, which describes determining a length of an ECS cycle. The determination may be based on an ECS cycle setting. For example, the setting may be stored in a settings register (e.g., 132 of FIG. 1) such as a fuse array or a mode register. The length may be determined based, in part, on an expected rate at which ECS commands are received.

Block 610 is followed by block 620, which describes receiving ECS commands and performing one or more ECS operations responsive to each of the ECS commands. The method 600 may include determining a number of the one or more ECS operations to perform based on the determined length of the ECS cycle. For example, the method 600 may include multiplying a base line number of ECS operations per ECS command by the value of the ECS cycle setting.

Block 620 is followed by block 630, which describes performing an ECS operation on each codeword of a memory array of a number of the ECS commands, where the number is based on the determined length of the ECS cycle. For example, the method 600 may include performing an ECS operation on each codeword over a first number of ECS commands for a first determined length and performing an ECS operation on each codeword over a second number of ECS commands for a second determined length. The number of ECS commands to complete an ECS cycle may be based, in part, on the number of the one or more ECS operations performed per ECS command. For example, if 2 ECS operations are performed per command, then the ECS cycle will be completed in half the number of ECS commands than if 1 ECS operation is performed per command.

The method 600 may include receiving the ECS commands at a rate. The rate may not vary even when the length of the ECS cycle varies. For example, the method 600 may include receiving the ECS commands at the rate for a first determined length or a second determined length of the ECS cycle. Since the rate may generally remain constant, the determined length of the ECS cycle may change the amount of time each ECS cycle takes.

In some embodiments, the method 600 may include receiving an access command for a different bank than the bank where the ECS operation is being performed and performing the access operation on the different bank during a tECS time for the first bank. For example, the method 600 may include performing the access operation on the different bank while performing the ECS operation. In some embodiments, the controller may count a number of ECS commands sent to the memory in order to determine which bank(s) are restricted during the tECS period.

The method 600 may include generating an ECS address for each of the ECS operations. For example, the method may include updating a bank counter (e.g., 222 of FIG. 2) to generate a bank address responsive to the first ECS operation performed responsive to an ECS command. The method 600 may include updating a codeword counter (e.g., 224 of FIG. 2) to generate a column address when the bank counter wraps or for each subsequent ECS operation performed responsive to the same ECS command. The method 600 may include updating a row address counter (e.g., 226 of FIG. 2) when the codeword counter wraps. The ECS address is formed from the bank, column, and row addresses.

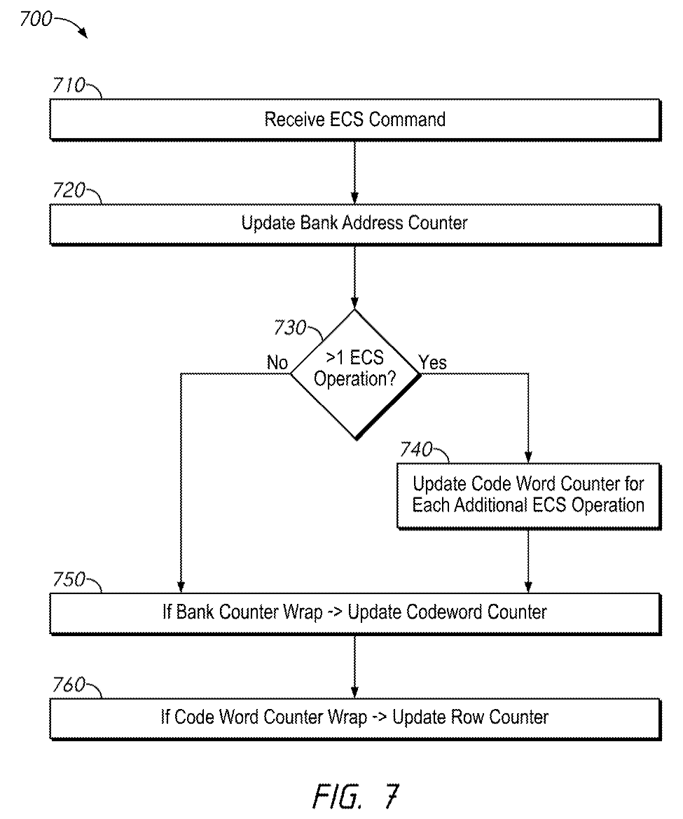

FIG. 7 is a flow chart of a method of generating an ECS address according to some embodiments of the present disclosure. The method 700 may, in some embodiments, be performed by one or more of the apparatuses, systems, or portions thereof described herein. For example, the method 700 may be performed by the memory device 100 of FIG. 1 and/or the ECS logic circuit 200 of FIG. 2. In some embodiments, the method 700 may implement a portion of the method 600 of FIG. 6. For example, the method 700 may be used as part of performing the ECS operation(s) responsive to an ECS command.

The method 700 may generally begin with block 710 which describes receiving an ECS command. For example, the ECS command may be received along C/A terminals of the memory device. The ECS command may be an MECS command in some embodiments.

Block 710 is followed by block 720 which describes updating a bank address counter (e.g., 222 of FIG. 2) responsive to the ECS command. For example, the bank address counter may be updated to generate a bank address which indicates a next bank in a sequence of banks. The method 700 includes generating a bank address based on the bank address counter.

Block 720 is followed by block 730 which describes determining if more than one ECS operation is being performed responsive to the ECS command received in block 710. The determination of block 730 may be based, at least in part, on an ECS cycle setting stored in a settings register (e.g., 132 of FIG. 1). The determination may be performed by an ECS state control circuit (134 of FIG. 1 and/or 212 of FIG. 2), an ECS address generator circuit (e.g., 220 of FIG. 2) or combinations thereof. For example, for a first ECS operation responsive to a command, the ECS state control circuit may provide an internal ECS signal and an ECS command signal, while on subsequent ECS operations just the internal ECS signal is provided.

If there is only one ECS operation being performed, then the method 700 proceeds from block 730 to block 750. If there is more than one ECS operations being performed, then the method 700 proceeds from block 730 to block 740. Block 740 describes updating a code word counter (e.g., 224 of FIG. 2) for each additional ECS operation after the first. The updating includes updating to a next column address in a sequence of column addresses. The method 700 includes generating a column address based on the code word counter. After block 740, the method 700 proceeds to block 750.

Block 750 describes updating the code word counter (e.g., similar to the update in block 740) if the bank counter wraps. Block 750 is followed by block 760, which describes updating a row counter (e.g., 226 of FIG. 2) if the code word counter wraps. For example, the updating may include updating to a next row in a sequence of rows. The method 700 may include generating a row address based on the row counter.

The method 700 includes forming an ECS address based on the values of the bank counter, code word counter, and row counter. The method 700 may include performing an ECS operation on the codeword indicated by the ECS address. Performing the ECS operation includes reading data and error correction bits from the codeword specified by the ECS address to the error correction circuit (e.g., 120 of FIG. 1), determining if the data includes an error and correcting the error if there is an error, and writing the corrected data back to the memory array.

In some embodiments, the method 700 may include receiving an access command for a second bank different than the bank specified by the bank address and performing an access operation on the second bank while performing the ECS operation on the bank. In some embodiments, the method may include counting a number of ECS commands with a controller of the memory and selecting the second bank based on the count.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a memory array;
a settings register configured to store an error check and scrub (ECS) cycle setting;
an ECS logic circuit configured to receive an ECS command and perform a number of ECS operations on the memory array, where the number is based on the ECS cycle setting.

2. The apparatus of claim 1, wherein the ECS logic circuit includes:
a bank counter configured to update a bank address responsive to the ECS command;
a code word counter configured to update a column address when the bank counter wraps;
a row counter configured to update a row address when the code word counter wraps,
wherein the ECS logic circuit is configured to generate an ECS address based on the bank address, column address and row address, and wherein the ECS address specifies a code word in the memory array for an ECS operation.

3. The apparatus of claim 2, wherein the code word counter is further configured to update the column address on a subsequent ECS operation responsive to a same ECS command.

4. The apparatus of claim 1, wherein the ECS cycle setting determines a number of ECS commands needed to perform ECS operations on each of the codewords of the memory array.

5. The apparatus of claim 1, wherein the ECS logic circuit further comprises a plurality of errors per row count (EpRC) counter circuits, each associated with one of a plurality of banks of the memory array, and wherein a selected one of the plurality of EpRC counter circuits is updated when an error is detected during the ECS operation in the associated one of the plurality of banks.

6. The apparatus of claim 1, wherein the ECS cycle setting changes a duration of an ECS cycle period.

7. The apparatus of claim 1, wherein the settings register includes a mode register, a fuse register, or both.

8. A method comprising:
determining a length of an error check and scrub (ECS) cycle of a memory device;
receiving ECS commands and performing one or more ECS operations responsive to each of the ECS command; and
performing an ECS operation on each codeword of a memory array over a number of the ECS commands, wherein the number is based on the determined length of the ECS cycle.

9. The method of claim 8, further comprising determining the length of the ECS cycle based on a value of an ECS cycle setting in a settings register.

10. The method of claim 8, selecting a number of the one or more ECS operations performed responsive to each of the ECS command, wherein the selected number of the one or more ECS operations is based on the determined length.

11. The method of claim 8, further comprising receiving the ECS commands at a same rate for a first determined length of the ECS cycle or a second determined rate of the ECS cycle.

12. The method of claim 8, further comprising performing each of the one or more ECS operations by generating an ECS address and performing the ECS operation on the codeword specified by the ECS address.

13. The method of claim 12, further comprising generating the ECS address by:
updating a bank address counter to generate a bank address responsive to the ECS command;
updating a code word counter to generate a column address when the bank address counter wraps; and
updating a row counter to generate a row address when the code word counter wraps,
wherein the ECS address comprises the bank address, the column address, and the row address.

14. The method of claim 8, further comprising changing which of a plurality of memory banks the one or more ECS operations are performed in for each of the received ECS commands.

15. A method comprising:
receiving an error check and scrub (ECS) command with a memory;
updating a bank address counter to generate a bank address responsive to the ECS command;
updating a code word counter to generate a column address when the bank address counter wraps;
updating a row counter to generate a row address when the code word counter wraps; and
performing an ECS operation on a code word in a memory array specified by the bank address, column address, and row address.

16. The method of claim 15, further comprising:
performing multiple ECS operations each on a respective codeword responsive to the ECS command; and
updating the code word counter for each of the multiple ECS operations after the first.

17. The method of claim 15, further comprising:
performing one or more of the ECS operations responsive to the ECS command; and
determining a number of the one or more ECS operations based on an ECS cycle setting.

18. The method of claim 15, further comprising receiving an access command for a second bank different than the bank specified by the bank address and performing an access operation on the second bank while performing the ECS operation.

19. The method of claim 15, further comprising:
counting a number of ECS commands with a controller of the memory; and
selecting the second bank based on the count.

20. The method of claim 15, further comprising performing the ECS operation by:
reading data and error correction bits from the codeword to an error correction circuit;
determining if the data includes an error and correcting the error if there is an error; and
writing the corrected data back to the memory array.
